(19) United States
(12) Patent Application Publication
(10) Pub. No.: US 2023/0175624 A1
(43) Pub. Date: Jun. 8, 2023

(54) Double Pipe System

(71) Applicant: Georg Fischer Rohrleitungssysteme AG, Schaffhausen (CH)

(72) Inventors: Markus BREYER, Radolfzell (DE); Juergen ROESCH, Lenzkirch (DE)

(21) Appl. No.: 18/074,591

(22) Filed: Dec. 5, 2022

(30) Foreign Application Priority Data
Dec. 7, 2021 (EP) 21 212 664.3

(51) Int. Cl. F16L 39/00; F16L 9/12; F16L 47/03; F16L 41/02

(52) U.S. Cl. CPC F16L 39/005; F16L 9/12; F16L 47/03; F16L 41/021

(57) ABSTRACT

Double pipe system with a primary pipeline conducting a medium and a secondary pipeline which is arranged around the primary pipeline for protection, containing pipes and fittings of the primary pipeline, wherein the pipes and fittings of the primary pipeline are connected together, and pipes and fittings of the surrounding secondary pipeline, wherein the pipes are configured as one-piece plastics pipes and the fittings are configured as half-shells, wherein the half-shells of the fittings and the adjoining pipes of the secondary pipeline are connected together by means of electric welding sleeves, or in that the half-shells of the fittings and the adjoining fittings consisting of half-shells are connected together by means of electric welding sleeves.

### CROSS-REFERENCE TO RELATED APPLICATION

This application claims the benefit and priority of European Patent Application No. 21 212 664.3 filed Dec. 7, 2021. The entire disclosure of the above application is incorporated herein by reference.

### BACKGROUND OF THE INVENTION

### Technical Field

The invention relates to a double pipe system and the method thereof for installation, with a primary pipeline conducting a medium and a secondary pipeline which is arranged around the primary pipeline for protection, containing pipes and fittings of the primary pipeline, wherein the pipes and fittings of the primary pipeline are connected together, and pipes and fittings of the surrounding secondary pipeline, wherein the pipes are configured as one-piece plastics pipes and the fittings are configured as half-shells.

### Discussion

Double pipe systems are either prescribed by law or are installed by the end users in order to prevent the unexpected escape of dangerous chemicals into the environment or to prevent injury to personnel. Moreover, double pipe systems are used, in particular, for the protection of expensive systems (machines, IT infrastructures). The secondary pipeline consists of a protective pipe which encloses the inner or primary fluid-conducting pipe. Secondary retaining systems can be designed to be either laid in the ground or above ground, under pressure or as a drainage system, and generally have a type of detection system for identifying leakages. The current systems are connected together by means of simultaneous welding or cascade welding. The connection technology varies significantly from continent to continent. In particular in Europe, however, the connections are increasingly implemented by a heat-welding process (in the case of polyolefins).

From the prior art it is known that fittings, which have been already prefabricated, are manufactured with an inner and outer fitting and these are then connected in each case to an inner and outer pipe. Due to the many different diameters of the inner and outer pipes and the different fittings such as T-pieces, angled pieces, etc. which have to be prefabricated, a large stock level is required, which nowadays is no longer desirable. Secondary containment pipes are manufactured in a similar manner, by a smaller inner/main pipe being inserted into a larger outer/containment pipe and being provided with a centring piece. The connection of the pipes to the shaped pieces is then the most difficult task. Existing systems require a considerable number of simultaneous connections for an installation. Typical adhesively bonded connections are carried out by initially applying a base coat onto both surfaces which fit together; then the cementite is applied onto both surfaces and then the parts which fit together are rapidly joined together, with a quarter rotation, and then the parts are tightly held for thirty seconds to a minute until the cementite has bonded. Understandably, this method is even more difficult to implement when attempts are made to produce an inner and an outer connection at the same time. There are twice as many surfaces which have to be prepared and the inner pipe has to be fastened to the protective pipe in order to ensure a complete insertion of the sleeve. Moreover, the inner connection is carried out “blind” when carrying out a simultaneous connection. Further drawbacks of the existing systems are additionally the lack of opportunity for inspecting the inner connection during pressure testing, and the difficulty of locating and repairing a faulty connection if a leak occurs.

It is the aspect of the invention to propose a double pipe system and a method associated therewith for the assembly thereof which permits a high degree of flexibility in the composition of a double pipe system without storing a large number of different parts and ensuring easy accessibility to the inner pipe and a reliable connecting technique.

This aspect is achieved in that the half-shells of the fitting and the adjoining pipes of the secondary pipeline are connected together by means of electric welding sleeves and in that the electric welding sleeve, which is temporarily arranged on the outer diameter of the pipe of the secondary pipeline, is partially pushed over the fitting consisting of the two half-shells and welded, or in that the half-shells of the fittings and the adjoining fittings consisting of half-shells are connected together by means of electric welding sleeves.

The double pipe system according to the preferred embodiment of the invention, with a primary pipeline conducting a medium and a secondary pipeline which is arranged around the primary pipeline for protection, contains pipes and fittings of the primary pipeline, wherein the pipes and fittings of the primary pipeline are connected together, preferably by welding or adhesive bonding. The pipes and fittings of the primary pipeline are preferably manufactured from plastics, but primary pipelines made of metal which are surrounded by a secondary pipeline made of plastics are also conceivable. Additionally, the double pipe system has pipes and fittings of the surrounding secondary pipeline, wherein the pipes are configured as one-piece plastics pipes and the fittings are configured as half-shells. The half-shells of the fittings and the adjoining pipes of the secondary pipeline are connected together by means of electric welding sleeves. Similarly, the fittings adjoining the fitting are also connected together by electric welding sleeves.

It has been shown to be advantageous if the electric welding sleeves are configured as one-piece hollow cylindrical sleeves. As a result, it is possible to use standard electric welding sleeves which during assembly are temporarily pushed onto the pipe of the secondary pipeline and, before the welding process, preferably pushed half way onto the fitting and then welded to the pipe and the fitting. The electric welding sleeves preferably have two heating elements, preferably heating wires, which are arranged on both sides of the sleeve and are welded in each case to the fitting and the pipe of the secondary pipeline.

Preferably, the half-shells are formed by a parting plane running centrally through the fitting along the axis. In other words, the two half-shells are preferably configured symmetrically.

It is advantageous if the fittings of the secondary pipeline have no heating elements, i.e. the half-shells have no heating elements.

It has been shown as a further advantageous embodiment if at least one half-shell of a fitting of the secondary pipeline has a seal running along the parting plane, wherein the seal in the region of the electric welding sleeve or in the connecting piece creates a material connection with the half-shells of the fitting after the electric welding sleeve is fixedly installed on the secondary pipeline and welded. The seal runs along the edge or the wall of the half-shell in the parting plane. The parting plane runs along the axis of the fitting and divides this fitting into two symmetrical half-shells. The seal preferably runs in the centre of the edge. It has been shown to be advantageous if the seal is arranged in the region of the connecting piece of the half-shells on the outer rim of the edge so that the seal has direct contact with the electric welding sleeve and is connected by a material connection thereto when heated.

It is advantageous if the pipes and fittings of the primary pipeline are connected together by electric welding. As a result, the same welding method can be used in the primary pipeline and in the secondary pipeline. Wherein other connecting methods, such as adhesive bonding or butt welding, are also conceivable for the primary pipeline.

Preferably, the fittings of the primary pipeline system are configured as electric-welded fittings.

The fittings are preferably configured as a T-piece, branching piece and/or as a curved piece. In other words, the T-piece, branching piece and/or the curved piece of the secondary pipeline are configured as half-shells and welded together during assembly by means of the electric welding sleeve.

It is advantageous if the half-shells of the fitting in each case have a connecting piece on the connection side, wherein the outer diameter of the connecting pieces preferably corresponds to the outer diameter of the pipe. The connecting pieces of the fitting have a smaller outer diameter than the central region of the fitting. As a result, the fitting or the half-shells have a shoulder against which the electric welding sleeve abuts during assembly and thereby the accurate position of the electric welding sleeve is predetermined, or the installer can identify how far the electric welding sleeve has to be pushed over the fitting so that it is correctly installed. In the variant where two fittings are welded together, it is advantageous if the fittings have markings on their connecting pieces, whereby it is displayed to the installer whether the electric welding sleeve is located at the correct position.

It has been shown to be advantageous if spacer elements are arranged in the fittings, wherein the spacer elements ensure the concentric arrangement of the primary pipeline and secondary pipeline. The primary and secondary pipelines are spaced apart from one another concentrically by the spacer elements. Additionally, the spacer element serves for the axial positioning of the fitting relative to the primary pipeline.

Preferably, spacer elements are also provided in the pipes, wherein these spacer elements do not have to be identical to those of the fitting.

As a preferred embodiment, the fitting of the secondary pipeline has at least one clip, wherein the clip serves to fix the half-shells temporarily to the primary pipeline. As a result, it is simpler to push the electric welding sleeve onto the fitting of the secondary pipeline. The clip can be attached retrospectively as a separate component in the half-shell or cast therein at the same time during injection-moulding.

A further preferred possibility is that the spacer element already has the property of providing a certain degree of self-locking on the primary pipeline, whereby the effect is also achieved that the fitting is temporarily fixed to the primary pipeline, so that the installer can push on the electric welding sleeve more easily since it is not necessary for it still to be held tightly.

The method according to the preferred embodiment of the invention for the installation of the double pipeline system includes:

Welding a sub-portion of the primary pipeline to at least one fitting and pipe, wherein preferably electric welding is used for welding the fittings and pipes of the primary pipeline. The welding is carried out in sub-portions in order, on the one hand, to test the welding and, on the other hand, to attach or feed on the pipes of the secondary pipeline in portions. The welding of the sub-portions of the primary pipeline is subdivided, such that at least on one side of the primary pipeline a pipe of the secondary pipeline can be pushed on.

Additionally, the electric welding sleeves are temporarily arranged on the outer diameter of a pipe of the secondary pipeline which is to be pushed onto the primary pipeline. Then the pipe of a secondary pipeline, on which the electric welding sleeve or electric welding sleeves is or are temporarily arranged, is pushed onto the pipe of the primary pipeline which is already welded to a fitting in a sub-portion. After the installation of the primary pipelines or a sub-portion, these can be pressure-tested and possible leakages identified.

Then the attachment of a fitting of the secondary pipeline takes place, preferably around a fitting of the primary pipeline, by combining or joining two half-shells together. Naturally, it is also possible to attach a fitting of the secondary pipeline, which consists of two half-shells, in order to attach a pipe of the primary pipeline. This is generally implemented at the bearing points at which the pipeline is fixed. In order to weld the secondary pipeline, the electric welding sleeve which is temporarily arranged on the outer diameter of the pipe of the secondary pipeline is partially pushed over the fitting of the secondary pipeline, consisting of the two half-shells, and welded. For the welding process, the electric welding sleeve is arranged with approximately half thereof on the pipe outer diameter and the other half thereof on the fitting.

Preferably, the electric welding sleeve is pushed over the connecting piece of the fitting of the secondary pipeline or the two half-shells, as far as a stop. Wherein due to the larger cross section the stop is preferably present in the central region of the fitting.

### DRAWINGS

An exemplary embodiment of the invention is described with reference to the figures, wherein the invention is not merely limited to the exemplary embodiment. In the figures:

FIG. 1 shows a detail of a double pipe system according to the invention with only one half-shell,

FIG. 2 shows a half-shell of the double pipe system according to the invention,

FIG. 2a shows a half-shell of the double pipe system according to the invention, in which in the region of the connecting pieces the seal is arranged on the outside,

FIG. 3 shows a portion of a double pipe system according to the invention,

FIG. 4 shows the method according to the invention for the installation of the double pipeline system in steps,

FIG. 5 shows the method according to the invention for the installation of the double pipeline system in steps,

FIG. 6 shows the method according to the invention for the installation of the double pipeline system in steps,

FIG. 7 shows a detail of a double pipe system according to the invention shown with only one half-shell with visible clips and

FIG. 8 shows two fittings connected together with an electric welding sleeve.

### DESCRIPTION OF THE PREFERRED EMBODIMENTS OF THE INVENTION

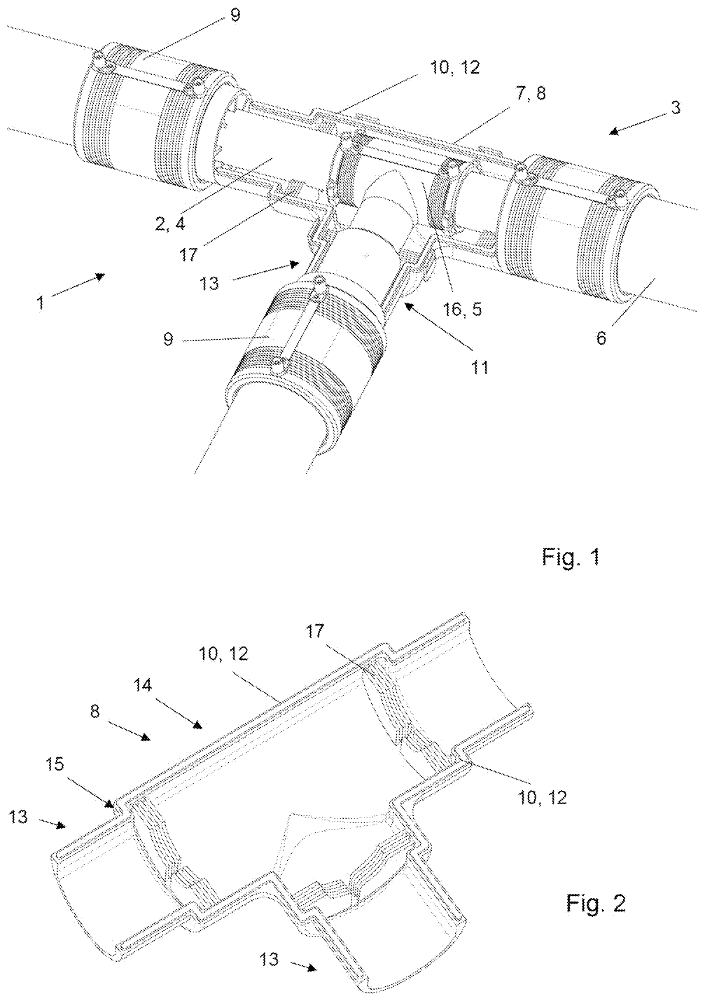

The drawing shown in FIG. 1 shows a three-dimensional view of a partially welded fitting 7 of the secondary pipeline 3, wherein the upper half-shell is masked out. The electric welding sleeve 9 shown on the right-hand side is already correctly placed on the fitting 7 and welded. However, the left-hand and lower electric welding sleeve 9 still has to be pushed onto the connecting piece 13 of the fitting 7. The double pipe system 1 according to the invention has a primary pipeline 2 through which medium circulates. The primary pipeline 2 has pipes 4 and fittings 5, which are welded together, preferably by electric welding sleeves 16, wherein other types of connection are also conceivable, such as for example adhesive bonding and butt welding. The primary pipeline 2 is preferably manufactured from plastics, wherein a metal pipeline is also perfectly conceivable as a primary pipeline.

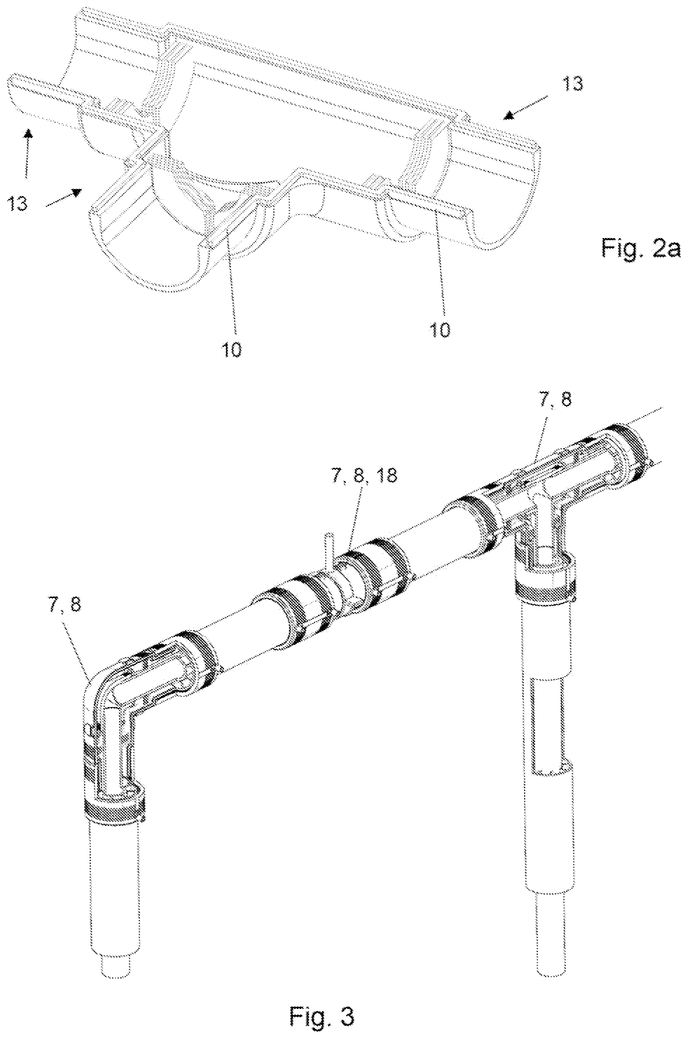

Moreover, the double pipe system 1 according to the invention contains a secondary pipeline 3, which is arranged around the primary pipeline system 2. The secondary pipeline 3 serves for protecting the environment or for protecting personnel from injury due to media escaping from leaking primary pipeline systems 2. The secondary pipeline 3 contains pipes 6 and fittings 7, wherein the fittings 7 are configured as half-shells 8. The pipes 6 are configured as one-piece plastics pipes and generally manufactured by extrusion. The pipes 6 are pushed over the pipe 4 of the primary pipeline 2, wherein only a sub-portion of the primary pipeline 2 is installed in order then to install the secondary pipeline 3. The two half-shells 8 of the fitting 7 of the secondary pipeline 3 are attached around the corresponding position of the primary pipeline 2. Generally, the position is also that of a fitting 5 of the primary pipeline 2 as shown in FIG. 1. The half-shells 8 of the fittings 7 can also be attached at other positions, for example where they serve as a bearing point 18 at which the double pipe system 1 is fastened, which can also be identified in FIG. 3. For a concentric arrangement of the two pipelines 2, 3, the half-shells 8 have spacer elements 17 on which the fittings 5, 7 are concentrically spaced apart from one another. Additionally, the spacer elements serve for the axial positioning of the half-shells 8. In FIG. 1 the path of the seal 10 which extends along the edge or wall 12 of the half-shell 8 is clearly visible. When welding by means of the electric welding sleeves 9 arranged on the fittings 7 of the secondary pipeline 3, the seal 10 is connected by a material connection to the half-shells 8 in the region of the electric welding sleeves 9. FIG. 2 shows a half-shell 8 of a fitting 7 of a secondary pipeline 3. The connecting pieces 13 are clearly visible, the electric welding sleeve 9 being pushed thereon for welding the half-shells 8 or the fitting 7. The shoulder 15 which is formed by the smaller diameter of the connecting piece 13 relative to the central region 14 of the half-shell 8 or the fitting 7 produces a stop for the electric welding sleeve 9, whereby the sleeve is correspondingly correctly positioned. Additionally, in turn the path of the seal 10 along the edge 12 of the half-shell 8 is clearly visible in FIG. 2 The seal 10 runs in the parting plane 11 of two half-shells 8 which form a fitting 7. An exemplary embodiment in which the seal 10 runs centrally over the entire edge of the half-shell 8 is shown in FIG. 2. An exemplary embodiment in which the seal 10 is arranged on the outside in the region of the connecting pieces 13 on the outer diameter thereof is shown in FIG. 2a, so that when welded to the electric welding sleeve 9 it can be connected directly thereto by a material connection. FIG. 3 shows different fittings 7 which are configured as half-shells 8. As an example, a T-piece is shown as a 90° angle, wherein other fittings such as branching pieces, curved pieces or half-shells for fastening points which are configured as bearing points 18 are also conceivable.

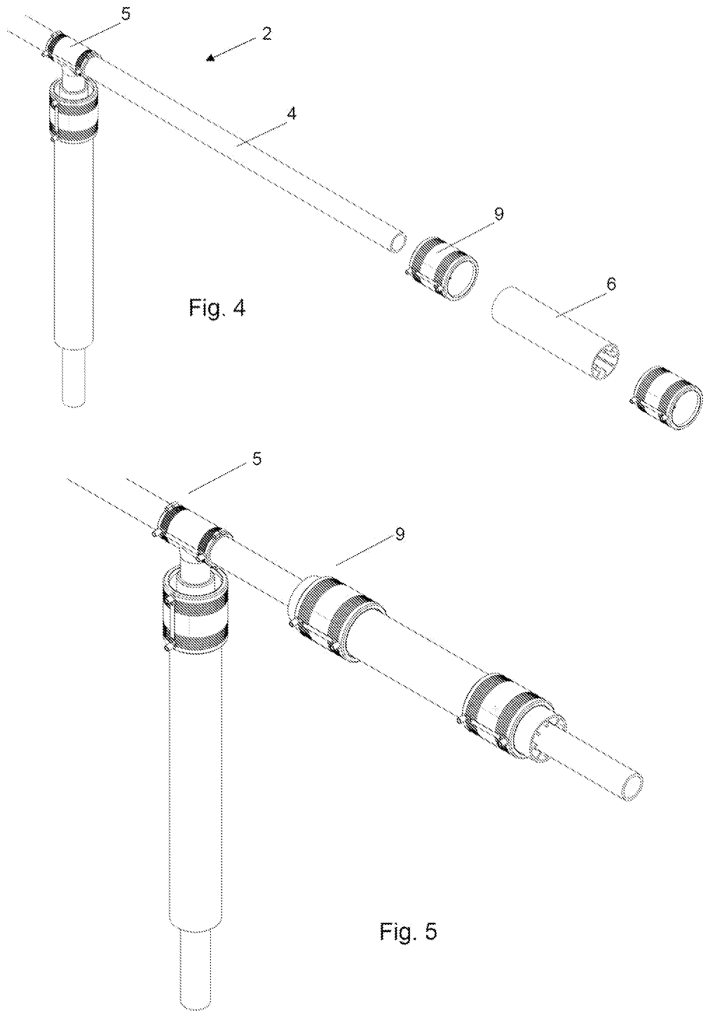

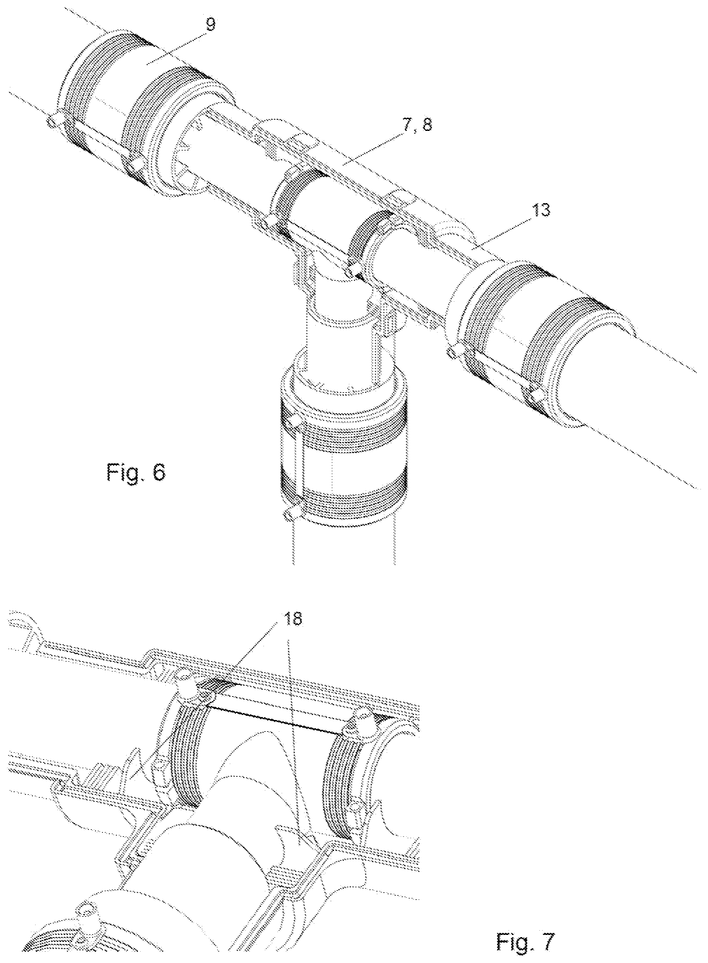

FIGS. 4-6 show the method according to the invention for the installation of the double pipe system 1 in steps. FIG. 4 shows the sub-region of the primary pipeline 2 which is already installed, preferably by welding the pipes 4 and fittings 5 so that the pipe 6 of the secondary pipeline 3 can be pushed thereover. However, the sub-region of the primary pipeline 2 is only welded such that at least one side of the primary pipeline 2 remains accessible for the secondary pipeline 3 to be pushed on. Additionally, FIG. 4 shows the preparation of the pipe 6 of the secondary pipeline 3 by an electric welding sleeve 9 being temporarily arranged on the outer diameter of the pipe 6 and then the pipe 6 and the electric welding sleeves 9 arranged on both sides of the pipe being pushed onto the sub-region of the primary pipeline 2. FIG. 5 shows how the pipe 6, with the electric welding sleeves 9 arranged thereon, is pushed onto the primary pipeline 2. FIG. 6 shows the pipe 6 of the secondary pipeline 2 pushed onto the fitting 7. Then the electric welding sleeves 9 are pushed onto the connecting piece 13 of the fitting 7 as far as the shoulder 15. Then the electric welding sleeves 9 are welded. This results in a double pipe system 1 as shown in FIG. 3. FIG. 7 shows an open fitting 7 of the secondary pipeline 3 or a half-shell 8 with the primary pipeline 2 running therein. Clearly visible are the clips 18 which are attached therein and which fasten the half-shells 8 in a simple manner to the primary pipeline 3 for assembly. This provides the advantage of a simple temporary arrangement of the half-shells 8 on the primary pipeline 2, which makes it easier for the installer to fasten the second half-shell and push on the electric welding sleeve 9.

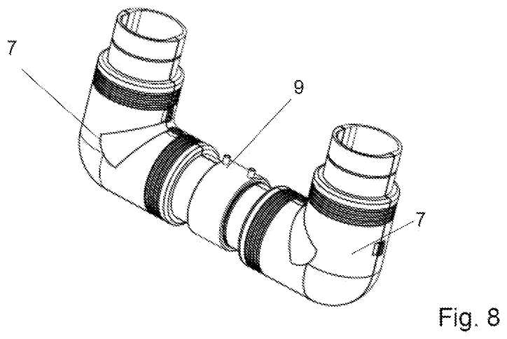

In FIG. 8 it is shown when two fittings 7 of the secondary pipeline 3 are directly welded together without a pipe piece therebetween. The electric welding sleeve 9 is then arranged in the centre of the two connecting pieces 13 of the fittings, wherein the axial positioning of the electric welding sleeve 9 is preferably predetermined by markings on the fittings.

What is claimed is:

1. A double pipe system (1) with a primary pipeline (2) conducting a medium and a secondary pipeline (3) which is arranged around the primary pipeline (2) for protection, containing pipes (4) and fittings (5) of the primary pipeline (2), comprising wherein the pipes (4) and fittings (5) of the primary pipeline (2) are connected together, and pipes (6) and fittings (7) of the surrounding secondary pipeline (3), wherein the pipes (6) are configured as one-piece plastics pipes and the fittings (7) are configured as half-shells (8), wherein the half-shells (8) of the fittings (7) and the adjoining pipes (6) of the secondary pipeline (3) are connected together by means of electric welding sleeves (9), or in that the half-shells (8) of the fittings (7) and the adjoining fittings (7) consisting of half-shells (8) are connected together by means of electric welding sleeves (9).

2. A double pipe system (1) according to claim 1, wherein the electric welding sleeves (9) are configured as one-piece hollow cylindrical sleeves.

3. A double pipe system (1) according to claim 1, wherein the half-shells (7) are formed by a parting plane running centrally through the fitting (7) along the axis.

4. A double pipe system (1) according to claim 1, wherein at least one half-shell (8) of a fitting (7) has a seal (10) running along a parting plane (11) running parallel to the axis, wherein the seal (10) in the region of the electric welding sleeve (9) creates a material connection with the half-shells (8) of the fitting (7) or the half-shells (7) and the electric welding sleeve (9).

5. A double pipe system (1) according to claim 1, wherein the pipes (4) and fittings (5) of the primary pipeline (2) are connected together by electric welding.

6. A double pipe system (1) according to claim 1, wherein the fittings (5) of the primary pipeline are configured as an electric welding sleeve (16).

7. A double pipe system (1) according to claim 1, wherein the fittings (5, 7) are configured as a T-piece, branching piece and/or as a curved piece.

8. A double pipe system (1) according to claim 1, wherein the half-shells (8) of the fitting in each case have a connecting piece (13) on the connection side, wherein the outer diameter of the connecting pieces (13) preferably corresponds to the outer diameter of the pipe (6).

9. A double pipe system (1) according to claim 1, wherein spacer elements (17) are arranged in the fittings (7), wherein the spacer elements (17) ensure the concentric arrangement of the primary pipeline and secondary pipeline to one another.

10. A double pipe system (1) according to claim 1, wherein at least one clip (18) is arranged in the fittings (7) in order to fix the half-shells (8) temporarily to the primary pipeline (2).

11. A method for the installation of the double pipe system according to claim 1, comprising:
welding a sub-portion of the primary pipeline (2) to at least one fitting (5) and at least one pipe (4),
temporarily arranging an electric welding sleeve (9) on the outer diameter of a pipe (6) of the secondary pipeline (3) which is to be pushed onto the primary pipeline (2),
pushing the pipe (6), with the electric welding sleeve (9) of a secondary pipeline (3) temporarily arranged thereon, onto the pipeline portion of the sub-portion of the primary pipeline (2) welded to a fitting (5),
attaching a fitting (7) of the secondary pipeline (3), preferably around a fitting (5) of the primary pipeline (2), by combining two half-shells (8),
wherein the electric welding sleeve (9) which is temporarily arranged on the outer diameter of the pipe (6) of the secondary pipeline (3) is partially pushed over the fitting (7), consisting of the two half-shells (8), and welded.
